(19) United States
(12) Patent Application Publication
(10) Pub. No.: US 2007/0230447 A1
(43) Pub. Date: Oct. 4, 2007

(54) APPARATUS, METHOD AND COMPUTER PROGRAM PRODUCT FOR A CORDLESS VOICE OVER IP PHONE

(75) Inventors: Bruce Hahn, Roswell, GA (US); Adam Somer, Atlanta, GA (US)

Correspondence Address: VENABLE LLP, P.O. BOX 34385, WASHINGTON, DC, 20043-9998, US

(73) Assignee: American Telecom Services, Inc., Industry, CA (US)

(21) Appl. No.: 11/685,572

(22) Filed: Mar. 13, 2007

Related U.S. Application Data
(60) Provisional application No. 60/781,315, filed on Mar. 13, 2006.

(51) Int. Cl. H04L 12/66

(52) U.S. Cl. 370/352

(57) ABSTRACT

An apparatus, system, method and computer program product for cordless radio frequency and voice over Internet protocol protocol includes a cordless component and a VOIP component. The cordless component is operable to communicate with one or more wireless handsets over a cordless radio frequency connection. The VOIP component is operable to communicate voice data over an Internet protocol connection to an IP network via packet data communications. The apparatus may include a master base station operable to communicate with one or more extension base stations remote from the master base station over a cordless RF connection, with each cordless extension operable to communicate with the wireless handset over a cordless RF connection. The cordless component and the VOIP component may be separated by a shield or insulator operable to reduce dispersal of heat or electromagnetic radiation between the components.

### CROSS REFERENCE TO RELATED APPLICATION

This application is related to co-pending U.S. Provisional Patent Application No. 60/781,315, Attorney Docket No. 63870-229319, entitled “Expandable Digital Spread Spectrum Cordless Broadband Telephone with Integrated Router,” to Hahn, et al, filed on Mar. 13, 2006, of common assignee to the present invention, the contents of which are incorporated herein by reference in its entirety.

### BACKGROUND OF THE INVENTION

1. Field of the Invention

The present invention relates generally to telecommunications hardware and services and, more particularly, to an apparatus for transmission of voice services over a packet data network and cordless radio frequency (RF) communications.

2. Related Art

A conventional cordless phone is a telephone with a wireless handset which communicates via radio waves with a local base station typically connected to a fixed public switched telephone network (PSTN) line. The cordless phone may only be operated within a range, near one hundred meters, of its base station, making the cordless phone ideal for household usage. The base station typically recharges the batteries of the wireless handset when the handset is placed in its cradle, and the batteries provide power to the handset during normal operation.

In 1986, the United States Federal Communications Commission (FCC) granted the frequency range of 47-49 megahertz (MHz) for cordless phones. The greater frequency range permitted cordless phones to have fewer problems associated with signal interference and to require less power for operation than conventional phones. By 1990, the FCC granted the 900 MHz frequency range for cordless phones. By 1994, digital cordless phones were introduced, and by 1995, digital spread spectrum (DSS) cordless phones were introduced. These technologies were designed to increase the security of cordless phones by permitting the communication to be dispersed digitally over a spectrum. By 1998, the FCC granted for cordless phones the much higher frequency range of 2.4 gigahertz (GHz), with the potential to increase upward to 5.8 GHz.

Voice over Internet protocol (VOIP) originated approximately in 1995, when data enthusiasts developed software to permit transmission of voice as packets of data over the Internet, primarily in order to avoid paying traditional long distance charges for switched voice services. In these first efforts, both callers were required to use computers equipped with a sound card, a microphone and Internet voice software. These early efforts were characterized by poor connectivity, sound quality, jitter and tremendous delays between speaking by a caller and hearing by the other caller.

Small companies were able to offer personal computer (PC) to phone services in the 1998 time frame due to gradual advancements in VOIP technology. Though communication between phones followed, a PC was still required to establish the connection.

Two significant advances followed. First, steady introduction of broadband Ethernet service permitted reduced call latency and improved call quality. However, difficulties still existed where data communications via the Internet met traditional PSTN facilities, causing unclear, static ridden connections.

The second important advance was when hardware manufacturers, such as Cisco Systems and Nortel began producing VOIP switching equipment, and traditional carriers as well as major startup companies, such as Level 3 Communications, began offering voice services over IP optimized data networks. The voice switching functions that had been formerly provided by massive processors, such as switching a voice data packet into a signal that can be read by a PSTN component, could now be done by less expensive devices, making VOIP hardware much more affordable. Major companies began implementing VOIP in their core, internal IP networks, and long distance providers started routing much of their calls over the Internet.

Since 2000, VOIP usage has expanded dramatically, while different technical standards have been used concurrently. Business users have often switched to VOIP to save on long distance and infrastructure costs. Recently, residential users have started to adopt VOIP service. VOIP technology is considered a viable alternative to existing switched voice services.

What is required is a merger of the recent technologies of cordless phone advances, with their ubiquitous usage, ease of deployment, secured transmissions, lesser interference, and benefit of wireless capability within a facility, with the benefits of VOIP, with its tremendous capacity to save revenue for business and residential voice services providers and consumers, as well as its ability to provide intelligent network management features and functions.

### SUMMARY OF THE INVENTION

Exemplary embodiments of the present invention set forth various exemplary embodiments of apparatuses, systems, methods and computer program products for providing transmission of voice services over a packet data network and cordless communications over radio frequencies (RF).

In an exemplary embodiment, the apparatus includes a cordless component operable to communicate with one or more wireless handsets over a cordless radio frequency (RF) connection, and a voice over Internet protocol (VOIP) component operable to communicate voice data over an Internet protocol (IP) connection to an IP network via packet data communications.

The apparatus may be a master base station operable to communicate with one or more extension base stations or handsets remote from the master base station over a cordless RF connection, with each cordless extension operable to communicate with a wireless handset over a cordless RF connection.

The cordless component and the VOIP component may be separated by a shield operable to reduce dispersal of heat and/or electromagnetic radiation, between the components. In one embodiment, the shield is further designed to interfere in a minimal capacity with the cordless RF communications and/or VOIP packet data communications of the apparatus.

The apparatus may include a master base station. In an embodiment, the cordless component includes a radio component for transmitting a cordless RF signal from the master base station to a cordless device, or receiving a cordless RF signal at the master base station from a cordless device. The apparatus may also include a power component, an input and output component, an interface, and a controller. In an embodiment, the power component recharges the power source of the master base station, and the input and output component receives an input into the master base station and/or transmits an output from the master base station. The interface may provide an interface with non-cordless devices, such as for example, to the public switched telephone network, or a data network. The controller may control the radio component, the power component, the input and output component and the interface of the master base station.

In an exemplary embodiment, the master base station uses a Digital Enhanced Cordless Telecommunications (DECT) standard, or a Personal Handy-phone System (PHS) standard.

The VOIP component may include a number of components. In an exemplary embodiment, the VOIP component includes a VOIP interface, a central processing unit (CPU), a local area network (LAN) interface, and a wide area network (WAN) interface. The VOIP interface may be operable to communicate with the controller. The central processing unit (CPU) may be operable to communicate with the VOIP interface and control the converting of a voice information bearing data packet to a digital cordless RF signal, and/or the converting of a digital cordless RF signal to a voice information bearing data packet. In an embodiment, the LAN interface communicates with a single digital device and/or a plurality of data devices connected over a LAN, and the WAN interface communicates with the Internet and/or another wide area data network. In one embodiment, the apparatus further includes a router connected with the WAN interface.

In an exemplary embodiment, a transport layer connection associated with the IP connection includes any one of: a transmission control protocol (TCP) connection; a user datagram protocol (UDP) connection; a datagram congestion control protocol (DCCP) connection; and a stream control transmission protocol (SCTP) connection.

In an exemplary embodiment, an application layer connection associated with the IP connection includes a session initiation protocol (SIP) connection of the Internet Engineering Task Force (IETF) and/or an H.323 connection of the International Telecommunication Union (ITU).

In another exemplary embodiment, a system is provided that includes the Internet protocol (IP) network; a plurality of wireless handsets; and a master base station. The master base station includes a cordless component operable to communicate with the wireless handsets over a cordless radio frequency (RF) connection, and a voice over Internet protocol (VOIP) component operable to communicate voice data over an IP connection to the IP network via packet data communications. In an exemplary embodiment, the system further includes one or more extension base stations remote from the master base station and operable to communicate with the master base station over a cordless RF connection, each extension base station operable to communicate with a wireless handset over a cordless RF connection.

In yet another exemplar embodiment, a method is provided that includes a first step of communicating with one or more wireless handsets over a cordless radio frequency (RF) connection, and a second step of communicating voice data over an Internet protocol (IP) connection to an IP network via packet data communications. In one embodiment, the first step and the second step are performed by a master base station, and a component operable to perform the first step and a component operable to perform the second step are separated by a shield operable to reduce dispersal of heat and/or electromagnetic radiation between the components.

In yet another exemplary embodiment, a machine readable medium that provides instructions is provided, which when executed by a computing platform, cause the computing platform to perform certain operations. The operations include communicating with one or more wireless handsets over a cordless radio frequency (RF) connection and communicating voice data over an Internet protocol (IP) connection to an IP network via packet data communications.

### BRIEF DESCRIPTION OF THE FIGURES

Various exemplary features and advantages of the invention will be apparent from the following, more particular description of exemplary embodiments of the present invention, as illustrated in the accompanying drawings wherein like reference numbers generally indicate identical, functionally similar, and/or structurally similar elements. The left most digits in the corresponding reference number indicate the drawing in which an element first appears.

FIG. 1 is an exemplary embodiment of a block diagram providing an overview of an exemplary telecommunications network providing exemplary local exchange carrier services within one or more local access and transport areas;

FIG. 2 is an exemplary embodiment of a block diagram illustrating an exemplary overview of a telecommunications network providing both local exchange carrier and interexchange carrier services between subscribers located in different local access and transport areas;

FIG. 3 illustrates an exemplary embodiment of a block diagram of an exemplary voice over data network providing what may be an exemplary competitive local exchange carrier service between subscribers;

FIG. 4 illustrates an exemplary master base station, extension base station, and cordless handsets according to embodiments of the present invention;

FIG. 5 illustrates a detailed illustration of exemplary features and functions of an exemplary cordless handset according to embodiments of the present invention;

FIG. 6 is a block diagram illustration of the components of an exemplary base station according to embodiments of the present invention;

FIG. 7 is a first illustration of a cordless voice over Internet protocol wireless device used in a data network according to embodiments of the present invention;

FIG. 8 is a second illustration of a cordless voice over Internet protocol wireless device used in a data network according to embodiments of the present invention;

FIG. 9 is a block diagram of a computer system that may be used in an exemplary embodiment of the present invention.

### DETAILED DESCRIPTION OF VARIOUS EXEMPLARY EMBODIMENTS OF THE INVENTION

A preferred as well as other exemplary embodiments of the invention are discussed in detail below. While specific exemplary embodiments are discussed, it should be understood that this is done for illustration purposes only. Persons skilled in the relevant art will recognize that other components, configurations, systems, methods and processes may be used without parting from the spirit and scope of the present embodiments.

### Overview of Exemplary Embodiments the Invention

An exemplary embodiment of the present invention represents an apparatus, system, method, and/or computer accessible medium adapted to enable transmission of voice services over a packet data network, such as voice over Internet protocol (VOIP), as well as cordless radio frequency (RF) communications. The system, method, and/or computer accessible medium according to the present embodiments are available from American Telecom Services, Inc., a DL Corporation, of 2466 Peck Road, City of Industry, CA 90601 USA.

### Exemplary Telecommunications Environment

The present invention may be described in terms of an exemplary telecommunications environment. The exemplary environment includes, for example, a multiple carriers telecommunications embodiment, as provided herein.

In the exemplary multiple carriers telecommunications embodiment, the device (described with respect to other exemplary embodiments) may be coupled to a telecommunications carrier according to any of a number of various methods specified herein or otherwise contemplated by skilled persons by reading this description.

According to the exemplary embodiment, the carriers may use any of a range of well known circuit switched and packet switched technologies, as well as telephony, video, other data, and/or a combination of the foregoing.

In this exemplary embodiment, the multiple telecommunications carriers may include US domestic entities (see Definitions below in Table 1 ) such as, for example, ILECs, CLECs, IXCs, NGTs and Enhanced Service Providers (ESPs), as well as global entities such as PTTs and NEs, recognized by those skilled in the art. In addition, as used herein a telecommunications system may include domestic systems used by entities such as, for example, ILECs, CLECs, IXCs and Enhanced Service Providers (ESPs), as well as global systems recognized by those skilled in the art. Skilled persons will recognize that the disclosed embodiments may be used with the entities and/or facilities of any locale, region or country as well with international entities and/or facilities.

In the exemplary embodiment, data and/or voice traffic may be transported over a heterogeneous network including telecommunications equipment and facilities of any of a number of the carriers or entities described herein.

Although the invention is described in terms of this exemplary environment, it is important to note that description in these terms is provided for purposes of illustration only. It is not intended that the invention be limited to this exemplary environment or to the precise inter-operations noted entities and devices. In fact, after reading the following description, it will become apparent to a person skilled in the relevant art how to implement the invention in alternative environments.

### Definitions

Table 1 below defines common telecommunications terminology. These terms may be used throughout the remainder of the description of the invention.

TABLE 1

| Term | Definition |
|---|---|
| automatic number | A telephone service that transmits the billing number (BN) and the telephone |
| identification (ANI) | number of the incoming call. ANI identifies the calling party for toll call |
| | billing and enables the call to be routed to the appropriate long distance service |
| | provider. ISDN supports ANI by carrying the calling telephone number in the D |
| | channel. ACD systems use the billing number to query a database and retrieve |
| | the customer's records. |
| access tandem (AT) | An AT is a class 3/4 switch may be used to switch calls between EOs in a LATA. |
| | An AT may provide subscribers access to the IXCs, to provide long distance |
| | calling services. An access tandem may be a network node. Other network |
| | nodes may include, for example, but not limited to, a CLEC, or other enhanced |
| | services provider (ESP), an international gateway or global point-of-presence |
| | (GPOP), or an intelligent peripheral(IP). |
| bearer (B) channels | Bearer (B) channels are digital channels may be used to carry both digital voice |
| | and digital data information. An ISDN bearer channel is 64,000 bits per second, |
| | which can carry PCM-digitized voice or data. |
| called party | The called party is the caller receiving a call sent over a network at the |
| | destination or termination end. |
| calling party | The calling party is the caller placing a call over any kind of network from the |
| | origination end. |
| central office (CO) | A CO is a facility that houses an EO homed. EOs are often called COs. |
| class 1 switch | A class 1 switching office, the Regional Center(RC), is the highest level of local |
| | and long distance switching, or “office of last resort” to complete a call. |
| class 3 switch | A class 3 switching office is a Primary Center (PC); an access tandem (AT) has |
| | class 3 functionality. |
| class 4 switch | A class 4 switching office is a Toll Center (TC) if operators is present or else a |
| | Toll Point (TP); an access tandem (AT) has class 4 functionality. |
| class 5 switch | A class 5 switching office is an end office (EO) or the lowest level of local and |
| | long distance switching, a local central office. The switch closest to the end |
| | subscriber. |
| competitive LEC | CLECs are telecommunications services providers of local services that can |
| (CLEC) | compete with ILECs. Level 3 Communications is an example. A CLEC may or |
| | may not handle IXC services as well. |
| competitive access | A company that provides exchange access services in competition with an |
| providers (CAPS) | established U.S. telephone local exchange carrier. |
| customer premises | CPE refers to devices residing on the premises of a customer and used to connect |
| equipment (CPE) | to a telephone network, including ordinary telephones, key telephone systems, |
| | PBXs, video conferencing devices and modems. |
| digitized data (or digital | Digitized data refers to analog data that has been sampled into a binary |
| data) | representation (i.e., comprising sequences of 0's and 1's). Digitized data is less |
| | susceptible to noise and attenuation distortions because it is more easily |
| | regenerated to reconstruct the original signal. |
| egress end office | The egress EO is the node or destination EO with a direct connection to the |
| | called party, the termination point. The called party is “homed” to the egress |
| | EO. |
| egress | Egress refers to the connection from a called party or termination at the |
| | destination end of a network, to the serving wire center (SWC). |
| end office (EO) | An EO is a class 5 switch used to switch local calls within a LATA. Subscribers |
| | of the LEC are connected (“homed”) to EOs, meaning that EOs are the last |
| | switches to which the subscribers are connected. |
| Enhanced Service | A network services provider. |
| Provider (ESP) | |
| equal access | 1+ dialing as used in US domestic calling for access to any long distance carrier |
| | as required under the terms of the modified final judgment (MFJ) requiring |
| | divestiture of the Regional Bell Operating Companies (RBOCs) from their parent |
| | company, AT&T. |
| global point of presence | A GPOP refers to the location where international telecommunications facilities |
| (GPOP) | and domestic facilities interface, an international gateway POP. |
| incumbent LEC (ILEC) | ILECs are traditional LECs in the US, which are the Regional Bell Operating |
| | Companies (RBOCs). Bell South and US West are examples. ILEC can also |
| | stand for an independent LEC such as a GTE. |
| ingress end office | The ingress EO is the node or serving wire center (SVC) with a direct connection |
| | to the calling party, the origination point. The calling party is “homed” to the |
| | ingress EO. |
| ingress | Ingress refers to the connection from a calling party or origination. |
| integrated service digital | An ISDN Basic Rate Interface (BRI) line provides 2 bearer B channels and 1 |
| network (ISDN) basic | data D line (known as “2B + D” over one or two pairs) to a subscriber. |
| rate interface (BRI) line | |
| integrated services | ISDN is a network that provides a standard for communications (voice, data and |
| digital network (ISDN) | signaling), end-to-end digital transmission circuits, out-of-band signaling, and |
| | a features significant amount of bandwidth. |
| inter machine trunk | An inter-machine trunk (IMT) is a circuit between two commonly-connected |
| (IMT) | switches. |
| inter-exchange carrier (IXC) | IXCs are US domestic long distance telecommunications services providers. |
| | AT&T, MCI, Sprint, are examples. |
| internet protocol (IP) | IP is part of the TCP/IP protocols. It is used to recognize incoming messages, |
| | route outgoing messages, and keep track of Internet node addresses (using a |
| | number to specify a TCP/IP host on the Internet). IP corresponds to the network |
| | layer of OSI. |
| Internet service provider | An ISP is a company that provides Internet access to subscribers. |
| (ISP) | |
| ISDN primary rate | An ISDN Primary Rate Interface (PRI) line provides the ISDN equivalent of a |
| interface (PRI) | T1 circuit. The PRI delivered to a customer's premises can provide 23B+D (in |
| | North America) or 30B+D (in Europe) channels running at 1.544 megabits per |
| | second and 2.048 megabits per second, respectively. |
| local exchange carrier | LECs are local telecommunications services providers. Bell Atlantic and US West |
| (LEC) | are examples. |
| local access and | A LATA is a region in which a LEC offers services. There are over 160 LATAs |
| transport area (LATA) | of these local geographical areas within the United States. |
| local area network | A LAN is a communications network providing connections between computers |
| (LAN) | and peripheral devices (for example, printers and modems) over a relatively short |
| | distance (for example, within a building) under standardized control. |
| network node | A network node is a generic term for the resources in a telecommunications |
| | network, including switches, DACS, regenerators, etc. Network nodes |
| | essentially include all non-circuit (transport) devices. Other network nodes can |
| | include, for example, equipment of a CLEC, or other enhanced service provider |
| | (ESP), a point-of-presence (POP), an international gateway or global point-of- |
| | presence (GPOP). |
| new entrant (NE) | A new generation global telecommunications. |
| next generation | A new telecommunications services provider, especially IP telephony providers. |
| telephone (NGT) | Examples are Level 3 and Qwest. |
| packetized voice or | One example of packetized voice is voice over internet protocol (VOIP). Voice |
| voice over a backbone | over packet refers to the carrying of telephony or voice traffic over a data |
| | network, for example, voice over frame, voice over ATM, voice over Internet |
| | protocol (IP), over virtual private networks (VPNs), voice over a backbone, etc. |
| pipe or dedicated | A pipe or dedicated communications facility connects an ISP to the internet. |
| communications facility | |
| point of presence (POP) | A POP refers to the location within a LATA where the IXC and LEC facilities |
| | interface. |
| point-to-point tunneling | A virtual private networking protocol, point-to-point tunneling protocol (PPTP), |
| protocol (PPTP) | can be used to create a “tunnel” between a remote user and a data network. A |
| | tunnel permits a network administrator to extend a virtual private network (VPN) |
| | from a server (for example, a Windows NT server) to a data network (for |
| | example, the Internet). |
| point-to-point (PPP) | PPP is a protocol permitting a computer to establish a connection with the |
| protocol | Internet using a modem. PPP supports high-quality graphical front ends, like |
| | Netscape. |
| postal telephone | State regulated telephone companies, many of which are being deregulated. NTT |
| telegraph (PTT) | is an example. |
| private branch exchange | A PBX is a private switch located on the premises of a user. The user is typically |
| (PBX) | a private company which desires to provide switching locally. |
| private line with a dial | A private line is a direct channel specifically dedicated to a customer's use |
| tone | between two specified points. A private line with a dial tone can connect a PBX |
| | or an ISP's access concentrator to an end office (for example, a channelized T1 |
| | or PRI). A private line can also be known as a leased line. |
| public switched | The PSTN is the worldwide switched voice network. |
| telephone network | |
| (PSTN) | |
| regional Bell operating | RBOCs are the Bell operating companies providing LEC services after being |
| companies (RBOCs) | divested from AT&T. |
| signaling system 7 (SS7) | SS7 is a type of common channel interoffice signaling (CCIS) used widely |
| | throughout the world. The SS7 network provides the signaling functions of |
| | indicating the arrival of calls, transmitting routing and destination signals, and |
| | monitoring line and circuit status. |
| switching hierarchy or | An office class is a functional ranking of a telephone central office switch |
| office classification | depending on transmission requirements and hierarchical relationship to other |
| | switching centers. Prior to AT&T's divestiture of the RBOCs, an office |
| | classification was the number assigned to offices according to their hierarchical |
| | function in the U.S. public switched network (PSTN). The following class |
| | numbers are used: class 1 = Regional Center(RC), class 2 = Sectional Center |
| | (SC), class 3 = Primary Center (PC), class 4 = Toll Center (TC) if operators are |
| | present or else Toll Point (TP), class 5 = End Office (EO) a local central office. |
| | Any one center handles traffic from one to two or more centers lower in the |
| | hierarchy. Since divestiture and with more intelligent software in switching |
| | offices, these designations have become less firm. The class 5 switch was the |
| | closest to the end subscriber. Technology has distributed technology closer to |
| | the end user, diffusing traditional definitions of network switching hierarchies |
| | and the class of switches. |
| telecommunications | A LEC, a CLEC, an IXC, an Enhanced Service Provider (ESP), an intelligent |
| carrier | peripheral (IP), an international/global point-of-presence (GPOP), i.e., any |
| | provider of telecommunications services. |
| transmission control | TCP is an end-to-end protocol that operates at the transport and sessions layers |
| protocol (TCP) | of OSI, providing delivery of data bytes between processes running in host |
| | computers via separation and sequencing of IP packets. |
| transmission control | TCP/IP is a protocol that provides communications between interconnected |
| protocol/internet | networks. The TCP/IP protocol is widely used on the Internet, which is a |
| protocol (TCP/IP) | network comprising several large networks connected by high-speed |
| | connections. |
| Trunk | A trunk connects an access tandem (AT) to an end office (EO). |
| wide area network | A WAN is a data network that extends a LAN over the circuits of a |
| (WAN) | telecommunications carrier. The carrier is typically a common carrier. A |
| | bridging switch or a router is used to connect the LAN to the WAN. |

### Exemplary Telecommunications Network —Voice Network —Simple Voice Network

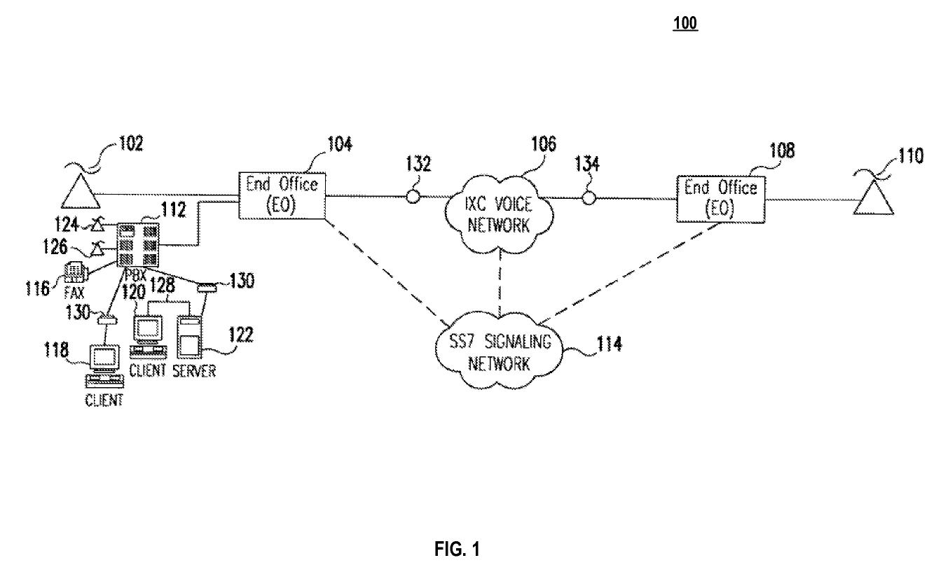

FIG. 1 is a block diagram providing an overview of a standard telecommunications network 100 providing local exchange carrier (LEC) services within one or more local access and transport areas (LATAs). Telecommunications network 100 can provide a switched voice connection from a calling party 102 to a called party 110. FIG. 1 is shown to also include a private branch exchange 112 which can provide multiple users access to LEC services by, for example, a private line. Calling party 102 and called party 110 can be ordinary telephone equipment, key telephone systems, a private branch exchange (PBX) 112 , or applications running on a host computer. Network 100 can be used for modem access as a data connection from calling party 102 to, for example, an Internet service provider (ISP) (not shown). Network 100 can also be used for access to, for example, a private data network. For example, calling party 102 can be an employee working on a notebook computer at a remote location who is accessing his employer's private data network through, for example, a dial-up modem connection.

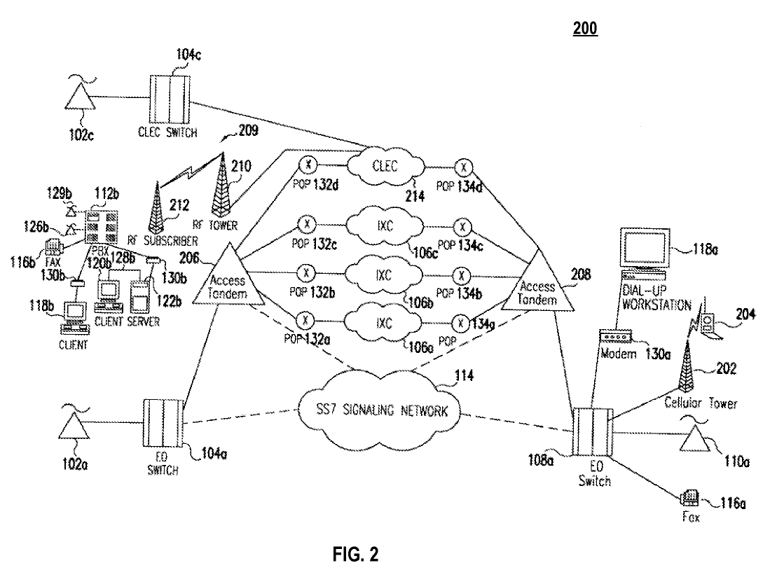

FIG. 1 includes end offices (EOs) 104 and 108. EO 104 is called an ingress EO because it provides a connection from calling party 102 to public switched telephone network (PSTN) facilities on the origination of a call. EO 108 is called an egress EO because it provides a connection from the PSTN facilities to a called party 110 on the termination of a call. In addition to ingress EO 104 and egress EO 108 , the PSTN facilities associated with telecommunications network 100 include an access tandem (AT) (not shown) at points of presence (POPs) 132 and 134 that can provide access to, for example, one or more inter-exchange carriers (IXCs) 106 for long distance traffic, as shown in FIG. 2. Alternatively, it would be apparent to a person having ordinary skill in the art that IXC 106 could also be, for example, a local exchange carrier (CLEC), or other enhanced service provider (ESP), an international gateway or global point-of-presence (GPOP), or an intelligent peripheral (IP).

FIG. 1 also includes a private branch exchange (PBX) 112 coupled to EO 104. PBX 112 couples calling parties 124 and 126 , fax 116 , client computer 118 and associated modem 130 , and local area network 128 having client computer 120 and server computer 122 coupled via an associated modem 130. PBX 112 is a specific example of a general class of telecommunications devices located at a subscriber site, commonly referred to as customer premises equipment (CPE).

Network 100 also includes a common channel interactive signaling (CCIS) network for call setup and call tear down. Specifically, FIG. 1 includes a Signaling System 7 (SS 7 ) signaling network 114.

### Exemplary Detailed Voice Network

FIG. 2 is a block diagram illustrating an overview of a standard telecommunications network 200 , providing both LEC and IXC carrier services between subscribers located in different LATAs. Telecommunications network 200 is a more detailed version of telecommunications network 100. Calling party 102a and called party 110a are coupled to EO switches 104a and 108a, respectively. In other words, calling party 102a is homed to ingress EO 104a in a first LATA, whereas called party 110a is homed to an egress EO 108a in a second LATA. Calls between subscribers in different LATAs are long distance calls that are typically routed to IXCs. Exemplary IXCs in the United States include AT&T, MCI and Sprint.

Telecommunications network 200 includes access tandems (AT) 206 and 208. AT 206 provides connection to points of presence (POPs) 132a, 132b, 132c and 132d. IXCs 106a, 106b and 106c provide connection between POPs 132a, 132b and 132c(in the first LATA) and POPs 134a, 134b and 134c(in the second LATA). Competitive local exchange carrier (CLEC) 214 provides an alternative connection between POP 132d and POP 134d. POPs 134a, 134b, 134c and 134d, in turn, are connected to AT 208 , which provides connection to egress EO 108a. Called party 110a can receive calls from EO 108a, which is its homed EO.

Alternatively, AT 206 can be replaced by, for example, a CLEC, or other enhanced service provider (ESP), an international gateway or global point-of-presence (GPOP), an intelligent peripheral, or the like.

Network 200 also includes calling party 102c homed to CLEC switch 104c. Following the 1996 Telecommunications Act in the United States, CLECs gained permission to compete for access within the local RBOCs territory. RBOCs are commonly referred to as incumbent local exchange carriers (ILECs).

Network 200 further may include a fixed wireless CLEC 209. Fixed wireless CLEC 209 includes a wireless transciever/receiver radio frequency (RF) tower 210 in communication over an RF link to a subscriber transciever RF tower 212. Subscriber RF tower 212 is depicted coupled to a CPE box, PBX 112b. PBX 112b couples calling parties 124b and 126b, fax 116b, client computer 118b and associated modem 130b, and local area network 128b having client computer 120b and server computer 122b coupled via an associated modem 130b.

Network 200 also includes called party 110a, a fax 116a, client computer 118a and associated modem 130 a, and cellular communications RF tower 202 and associated cellular subscriber called party 204 , all coupled to EO 108a, as shown.

EO 104a, 108a and AT 206, 208 are part of a switching hierarchy. EO 104a is known as a class 5 office and AT 208 is a class 3/4 office switch. Prior to the divestiture of the regional Bell Operating Companies (RBOCs) from AT&T following the modified final judgment, an office classification was the number assigned to offices according to their hierarchical function in the U.S. public switched network (PSTN). An office class is a functional ranking of a telephone central office switch depending on transmission requirements and hierarchical relationship to other switching centers. A class 1 office was known as a Regional Center (RC), the highest level office, or the “office of last resort” to complete a call. A class 2 office was known as a Sectional Center (SC). A class 3 office was known as a Primary Center (PC). A class 4 office was known as either a Toll Center (TC) if operators were present, or otherwise as a Toll Point (TP). A class 5 office was an End Office (EO), such as a local central office, the lowest level for local and long distance switching, and was the closest to the end subscriber. Any one center handles traffic from one or more centers lower in the hierarchy. Since divestiture and with more intelligent software in switching offices, these designations have become less firm. Technology has distributed functionality closer to the end user, diffusing traditional definitions of network hierarchies and the class of switches.

### Connectivity to Internet Service Providers (ISPs)

In addition to providing a voice connection from calling party 102a to called party 110a, the PSTN can provide calling party 102a a data connection to an ISP (similar to client 118b).

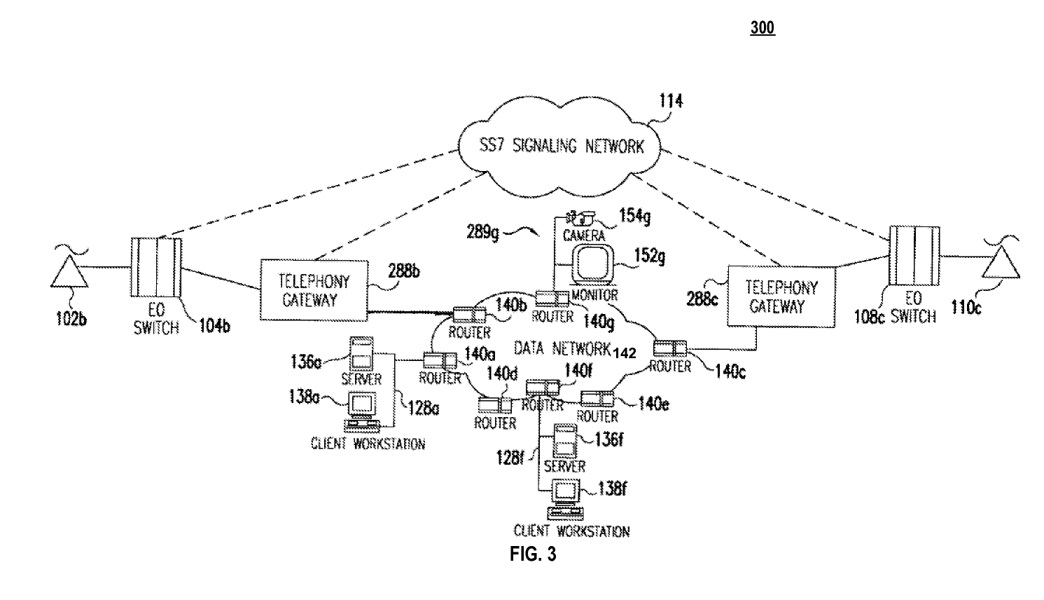

Network 200 can also include an Internet service provider (ISP) (not shown) which could include a server computer 122 coupled to a data network, as discussed further with reference to FIG. 3. The Internet is a well-known, worldwide network comprising several large networks connected together by data links. These links can include, for example, Integrated Digital Services Network (ISDN), T1, T3, FDDI and SONET links. Alternatively, as used herein, an internet can be a private network interconnecting a plurality of LANs and/or WANs, such as, for example, an intranet. An ISP can provide Internet access services for subscribers such as client 118b.

As one example, in order to establish a connection with an ISP, client 118b can use a host computer connected to a modem (modulator/demodulator) 130b. The modem can modulate data from the host computer into a form (traditionally an analog form) for transmission to the LEC facilities. Typically, the LEC facilities convert the incoming analog signal into a digital form. In one embodiment, the data is converted into the point-to-point protocol (PPP) format. (PPP is a well-known protocol that permits a computer to establish a connection with the Internet using a standard modem. It supports high-quality, graphical user-interfaces.) As those skilled in the art will recognize, other formats are available, including, for example, a transmission control program, internet protocol (TCP/IP) packet format, a user datagram protocol, internet protocol (UDP/IP) packet format, an asynchronous transfer mode (ATM) cell packet format, a serial line interface protocol (SLIP) protocol format, a point-to-point (PPP) protocol format, a point-to-point tunneling protocol (PPTP) format, a NETBIOS extended user interface (NETBEUI) protocol format, an Appletalk protocol format, a DECnet, BANYAN/VINES, an internet packet exchange (IPX) protocol format, and an internet control message protocol (ICMP) protocol format.

### Communications Links

Note that FIGS. 1, 2 and other figures described herein include lines which may refer to communications lines or which may refer to logical connections between network nodes, or systems, which are physically implemented by telecommunications carrier devices. These carrier devices include circuits and network nodes between the circuits including, for example, digital access and cross-connect system (DACS), regenerators, tandems, copper wires, and fiber optic cable. It would be apparent to persons having ordinary skill in the art that alternative communications lines can be used to connect one or more telecommunications systems devices. Also, a telecommunications carrier as defined here, can include, for example, a LEC, a CLEC, an IXC, an Enhanced Service Provider (ESP), a global or international services provider such as a global point-of-presence (GPOP), and an intelligent peripheral.

EO 104a and AT 206 are connected by a trunk. A trunk connects an AT to an EO. A trunk can be called an inter machine trunk (IMT). AT 208 and EO 108a are connected by a trunk which can be an IMT.

Referring to FIG. 1, EO 104 and PBX 112 can be connected by a private line with a dial tone. A private line can also connect an ISP (not shown) to EO 104 , for example. A private line with a dial tone can be connected to a modem bay or access converter equipment at the ISP. Examples of a private line are a channelized T1 or integrated services digital network (ISDN) primary rate interface (PRI). An ISP can also attach to the Internet by means of a pipe or dedicated communications facility. A pipe can be a dedicated communications facility. A private line can handle data modem traffic to and from an ISP.

Trunks can handle switched voice traffic and data traffic. For example, trunks can include digital signals DS1-DS4 transmitted over T1-T4 carriers. Table 2 provides typical carriers, along with their respective digital signals, number of channels, and bandwidth capacities.

TABLE 2

| Digital | Number of | Designation | Bandwidth in Megabits |
|---|---|---|---|
| signal | channels | of carrier | per second (Mbps) |
| DS0 | 1 | None | 0.064 |
| DS1 | 24 | T1 | 1.544 |
| DS2 | 96 | T2 | 6.312 |
| DS3 | 672 | T3 | 44.736 |
| DS4 | 4032 | T4 | 274.176 |

Alternatively, trunks can include optical carriers (OCs), such as OC-1, OC-3, etc. Table 3 provides typical optical carriers, along with their respective synchronous transport signals (STSs), International Telecommunications Union (ITU) designations, and bandwidth capacities.

TABLE 3

| | Electrical signal, | International | |
|---|---|---|---|
| Optical | or synchronous | Telecommunications | Bandwidth in |
| carrier | transport | Union (ITU) | Megabits per |
| (OC) signal | signal (STS) | terminology | second (Mbps) |
| OC-1 | STS-1 | | 51.84 |
| OC-3 | STS-3 | STM-1 | 155.52 |
| OC-9 | STS-9 | STM-3 | 466.56 |
| OC-12 | STS-12 | STM-4 | 622.08 |
| OC-18 | STS-18 | STM-6 | 933.12 |
| OC-24 | STS-24 | STM-8 | 1244.16 |
| OC-36 | STS-36 | STM-12 | 1866.24 |
| OC-48 | STS-48 | STM-16 | 2488.32 |

As noted, a private line is a connection that can carry data modem traffic. A private line can be a direct channel specifically dedicated to a customer's use between two specified points. A private line can also be a leased line. In one embodiment, a private line is an ISDN/primary rate interface (ISDN PRI) connection. An ISDN PRI connection can include a single signal channel (called a data or D channel) on a T1, with the remaining 23 channels being used as bearer or B channels, which are digital channels that bear voice and data information. If multiple ISDN PRI lines are used, the signaling for all of the lines can be carried over a single D channel, freeing up the remaining lines to carry only bearer channels.

### Telecommunications Traffic

Telecommunications traffic can be sent and received from any network node of a telecommunications carrier. A telecommunications carrier can include, for example, a LEC, a CLEC, an IXC, and an Enhanced Service Provider (ESP). In an embodiment, this traffic can be received from a network node which is, for example, a class 5 switch, such as EO 104a, or from a class 3/4 switch, such as AT 206. Alternatively, the network system can also be, for example, a CLEC, or other enhanced service provider (ESP), an international gateway or global point-of-presence (GPOP), or an intelligent peripheral.

Voice traffic refers, for example, to a switched voice connection between calling party 102a and called party 110a. It is important to note that this is on a point-to-point dedicated path, meaning that bandwidth is allocated whether it is being used or not. A switched voice connection is established between calling party 102a and EO 104a, then to AT 206 then over an IXC's network such as that of IXC 106a to AT 208 and then to EO 108a and over a trunk to called party 110a. In another embodiment, AT 206 or IXC 106a can also be, for example, a CLEC, or other enhanced service provider (ESP), an international gateway or global point-of-presence (GPOP), or an intelligent peripheral.

It is possible that calling party 102a is a computer with a data connection to a server over the voice network. Data traffic refers, for example, to a data connection between a calling party 102a(using a modem) and a server 122b that could be part of an ISP. A data connection can be established, for example, between calling party 102a and EO 104a, then to AT 206 , then to CLEC 214 , then over a fixed wireless CLEC 209 link to PBX 112b to a modem 130b associated with server 122b.

As described in other embodiments herein, a voice over Internet protocol (VOIP) call may also be made and telephony and other data may be delivered over a data network, such as shown in FIG. 3.

### SS7 Signaled Call Flow

The call between the originating caller and the terminating caller may use an intelligent network. An exemplary intelligent network is signaling system 7 (SS7 ). An exemplary SS7 network 114 can be used for any of the following functions: (i) basic call setup, management, and tear down; (ii) wireless services such as personal communications services (PCS), wireless roaming, and mobile subscriber authentication; (iii) local number portability (LNP); (iv) toll-free and toll wireline services; (v) enhanced call features such as call forwarding, calling party name/number display, and three-way calling; and (vi) efficient and secure worldwide telecommunications.

### Convergence

Intelligent networks, such as SS7 , illustrated that providing soft switch capability and data networking offers tremendous features and functionality to existing switched voice services. Full convergence of voice and data provides added ability to manage and enhance the network, as well as provide tremendous cost savings for callers. The digitization and transmission of voice and data over a converged packet-switched network makes use of the inherent efficiency of packet-switched data networks such as the Internet. As voice services are delay sensitive, large bandwidth and increased provisioning for quality of service (QoS) make convergence possible.

FIG. 3 illustrates an example network 300 carrying voice, data and video traffic over a data network. Network 300 includes calling party 102b homed to EO 104b, where EO 104b is linked to a telephony gateway 288b. Network 300 also includes called party 110c homed to EO 108c, where EO 108c is linked to a telephony gateway 288c. EOs 104b and 108c and telephony gateways 288b and 288c can be linked to signaling network 114. Telephony gateways 288b and 288c can also be coupled to a data network 142 via routers 140b and 140c, respectively.

In FIG. 3, telephony gateways 288b and 288c can be used to packetize voice traffic and signaling information into a form appropriate for transport over data network 142. Telephony gateways 288b and 288c may include various computer devices designed for controlling, setting up and tearing down calls. Voice calls delivered over the data network may include, without limitation, voice over packet (VOP), voice over data (VOD), voice over internet protocol (VOIP), voice over asynchronous transfer mode (VOATM), voice over frame (VOF), or a combination of the foregoing. An example of a telephony gateway 288b and 288c is a media gateway control protocol (MGCP). Other network devices, such as a computer operated switch or soft switch may also be used to enable transport of voice traffic, such as VOIP.

Network 300 is shown to include other devices coupled to data network 142. For example, an H.323 compliant video-conferencing system 289 is illustrated including a camera 154g and television 152g and router 140g. Second, a local area network (LAN) 128a including a client workstation 138a and a server 136a are coupled to data network 142 via network router 140a. Similarly, LAN 128f having a client workstation 138f and a server 136f are coupled via network router 140f to data network 142.

Data Network 142 can provide for routing of packets of information through network routing devices from source locations to destination locations coupled to data network 142. For example, data network 142 can route internet protocol (IP) packets for transmission of voice and data traffic from telephony gateway 288b to telephony gateway 288c. Data Network 142 represents any art-recognized packet centric data network. One well-known data network is the global Internet. Other examples include a private intranet, a packet-switched network, a frame relay network, and an asynchronous transfer mode (ATM) circuit-centric network.

In an example embodiment, data network 142 can be an IP packet-switched network. A packet-switched network such as, for example, an IP network, unlike a circuit-switched network, does not require dedicated circuits between originating and terminating locations within the packet switched network. The packet-switched network instead breaks a message into pieces known as packets of information. Such packets can then be encapsulated with a header which designates a destination address to which the packet must be routed. The packet-switched network then takes the packets and routes them to the destination designated by the destination address contained in the header of the packet.

Routers 140a, 140b, 140c, 140d, 140e, 140f and 140g can be connected to one another via physical media such as, for example, optical fiber link connections, copper wire connections, wireless connections, and the like. Routers 140a-g transfer information between one another and intercommunicate according to routing protocols.

Data network 142 could be implemented using any data network such as, for example, IP networks, ATM virtual circuit-centric networks, frame relay networks, X.25 networks, and other kinds of LANs and WANs. Other data networks could be used interchangeably for data network 142 such as, for example, FDDI, Fast Ethernet, or an SMDS packet switched network. Frame relay and ATM are connection-oriented, circuit-centric services. Switched multi-megabyte data service (SMDS) is a connection-oriented mass packet service that offers speeds up to 45 Mbps. Any combination of the foregoing may be used as well. Additional convergence devices and systems are described below.

Exemplary Cordless VOIP Device

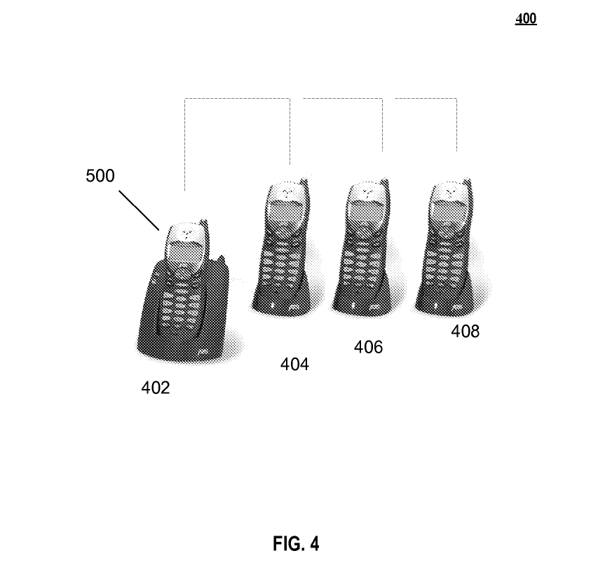

FIG. 4 provides exemplary environment 400. Exemplary environment 400 includes an exemplary master base station 402 , exemplary extension base stations 404, 406 and 408, and one or more exemplary wireless handsets 500. Each wireless handset 500 may be a handset communicating over radio frequency (RF) waves with either master base station 402 or any one of extension base stations 404-408 in an exemplary embedment. Master base station 402 may be connected to a fixed PSTN telephone line to provide access and egress for voice services. When a handset 500 is closest to a given extension base station 406 , the extension base station may provide RF communication to master base station 402 , which in turn may provide communication with the PSTN as described above, for an inbound or outbound call.

In certain embodiments, the range of the wireless handset 500 for communication with a given station 402-408 may be approximately 100 meters, and the base stations 402-408 and wireless handset communicate in the 2.4 GHz frequency range.

In certain embodiments, the wireless handset 500 and base stations 402-408 may use digital spread spectrum technology, with expandable frequency ranges. Here, the telecommunications signal may be transmitted on a bandwidth larger than the frequency content of the original information, itself. In certain embodiments, direct sequence, frequency hopping or a hybrid of the aforementioned may be employed for multiple access or multiple functions, to provide decreased interference as compared to conventional phones while providing privacy for the callers. For example, in certain embodiments a sequential noise resembling signal structure may be used to spread a normally narrowband information signal over a wideband RF.

In certain embodiments, the wireless handset 500 and base stations 402-408 may employ one or more cordless telephone standards. As one example, the devices may employ the Digital Enhanced Cordless Telecommunications (DECT) standard, which is a European Telecommunications Standards Institute (ETSI) standard for digital portable phones. DECT may also be used for wireless data transfers, and may qualify as a 3 G system by fulfilling the International Mobile Telecommunications-2000(IMT-2000) requirements. DECT is also referred to as IMT-FT (Frequency Time).

As another example, the wireless handset 500 and base stations 402-408 employ the Personal Handy-phone System (PHS), also known as Personal Access System (PAS), or as Xiaolingtong in China. This standard is a mobile network system for the 1880-1930 MHz frequency band, used predominantly in Japan, China, Taiwan and certain other Asian countries.

In certain embodiments, the wireless handset 500 and base stations 402-408 may employ mobile telephone features and functionality (not shown). Examples may include, but are note limited to, supporting cell handover, providing advanced features such as data transfer and/or providing international roaming. In exemplary embodiments, base stations for the devices are maintained by a mobile network operator and the user subscribes to the service.

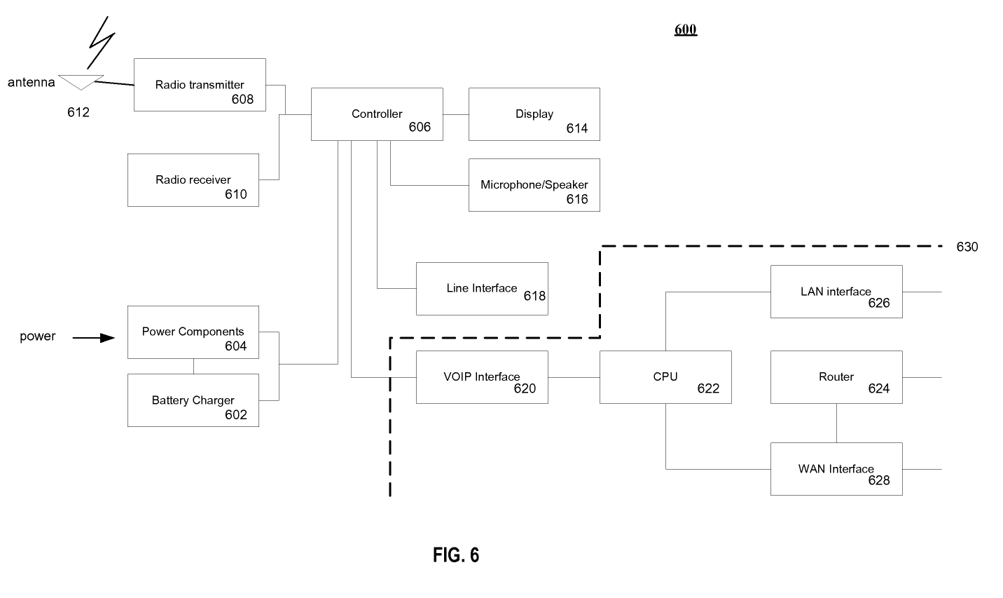

In addition, in certain embodiments, the wireless handset 500 and base stations 402-408 may enable transmission of voice services over a packet data network connection. For example, a voice over Internet Protocol (VOIP) connection for inbound or outbound calls may be provided over the Internet. In an exemplary embodiment, master base station 402 (and corresponding processes) enables transmission of voice services over a packet data network, such as voice over Internet protocol (VOIP), as well as cordless radio frequency (RF) communications. These embodiments are further described with reference to FIGS. 6-8.

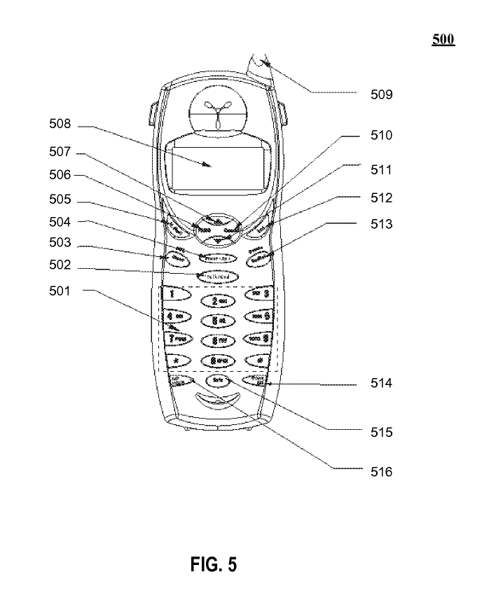

FIG. 5 illustrates the features and functions of handset 500 of an embodiment in greater detail. As shown, wireless handset 500 may include keypad 501, start/end calls 502, clear/delete 503, flash/speakerphone 504, voice mail 505, program 506, volume increase 507, display 508, cancel operation 510, volume decrease 511, intercom 512, redial/pause 513, repeat dial 514, directory information 515 and last call retrieval 516. As understood by skilled persons, any additional features and functions of modem cordless and/or cellular devices may be provided without departing from the embodiments described herein. As merely one example, a touch sensitive display may be used in addition to or in place of keypad 501 and/or display 508.

FIG. 6 depicts an exemplary a block diagram illustrating the components 600 of an exemplary base station 402 according to embodiments of the present invention. Components 600 may include antenna 612, radio transmitter 608, radio receiver 610, controller 606, power components 604, battery charger 602, display 614, microphone/speaker 616, line interface 618, VOIP interface 620, central processing unit (CPU) 622, local area network (LAN) interface 626, wide area network (WAN) interface 624, and router 628.

The antenna 612, radio transmitter 608 and radio receiver 10 respectively comprise exemplary radio components of the master base station 402. The master base station 402 and a wireless handset 500 can communicate through two-way radio communication within an area. In an embodiment, the range of the wireless handset 500 for communication with a given station 402-408 may be approximately 100 meters, and the base stations 402-408 and wireless handset may communicate in the 2.4 GHz frequency range using spread spectrum technology.

The radio transmitter 608 may convert audio signals into radio waves for transmission from the master base station 402 to a wireless handset 500. The radio may receive 610 receives the radio waves from a wireless handset 500, and detects and demodulates the waves into the audio signals. Antenna 612 may transmit and receive the waves between the wireless handset 500 and the master base station 402. An exemplary antenna may be a helical antenna. The foregoing radio components may include additional components for separating the input and output signals, such as a duplexer or other filter, for upconverting or downconverting the frequency of the radio waves, such as mixers, and for increasing the strength of the signal, such as an amplifier.

External power may be input to power components 604 and battery charger 602 which may supply voltage power to the circuits and may recharge the battery of the handset. For example, a direct current power cube transformer may be used to supply low voltage required by the electrical components on the circuit board. The power components 604 on the circuit board may work with the transformer to supply electrical current to recharge the battery of the wireless handset 500.

Phone line interface component 618 may perform a number of functions. It may transmit a ringer signal to a sound device on the master base station (not shown) or to the radio components for broadcast to the wireless handset, to inform the caller of an incoming call. It may also provide a communications interface with the calling or called party via the PSTN, through the control of the controller 606. In differing embodiments, the signal may be transmitted through analog or digital communications.

The microphone/speaker component 616 may include a transmitting section that may convert voice of users into audio signals. It may also include a receiving section which may receive audio signals and generates voice. Accordingly, microphone/speaker component 616 may provide input to and output from the master base station 402. A speaker may be used for providing ringing ring tones. A microphone may include, for example, an electronic condenser microphone or a dynamic microphone.

A display component 614 may also be provided. In an embodiment, display component 614 may include or control a light emitting diode (LED) display for illustrating the power level and whether the wireless handset 500 set in the cradle is charging, and a liquid crystal display (LCD) for caller identification.

In addition to the above, master base station 402 may also include any number of additional features and functions, such as, audio amplifiers for driving speakers for speaker phone features, a keypad for dialing numbers, and solid state memory for answering machine and/or call-back features.

In an exemplary embodiment, controller 606 may control all the foregoing cordless operations of the master base station 402. For example, controller 606 may include a central processing unit (CPU), memory, and/or a communications bus for communications with the other components. A non-exclusive list of exemplary types of memory may include read only memory (ROM), electronically erasable programmable read only memory (EEPROM), random access memory (RAM), read only memory (ROM), and the like.

In an exemplary embodiment, excepting the line interface functions, which may be employed solely by the master base station 402, extension base stations 404-408 and wireless handset 500 may include all of the foregoing features and functions.

In an exemplary embodiment, components 600 also includes a data networking component. The data networking component includes VOIP interface 620, central processing unit 622, local area network (LAN) interface 626, wide area network (WAN) interface 628 and/or router 624.

In this embodiment, controller 606, optional separate controller CPU 622, either individually, or in combination thereof, process calls to or from a data network. If controller 606 incorporates all data network functions, an additional controller, such as CPU 622, need not be used. CPU 622 may include additional elements, such as memory, and a communications bus for fast communications with the other components, similarly to controller 606. VOIP interface provides an interface between the cordless RF operation of master base station 402 and packet data operation of master base station 402.

In an exemplary embodiment, the above controller(s) may control the conversion of voice information bearing data packets, received from a data network, to a cordless RF signal, for transmission over radio transmitter 608 and antenna 612 to either a wireless handset 500 or an extension base station 404-408. In this embodiment, the above controller(s) may also control the reverse communications, namely the conversion of a cordless RF signal, received over radio receiver 610 from antenna 612 from either a wireless handset 500 or an extension base station 404-408, to voice information bearing data packets, for transmission to a data network.

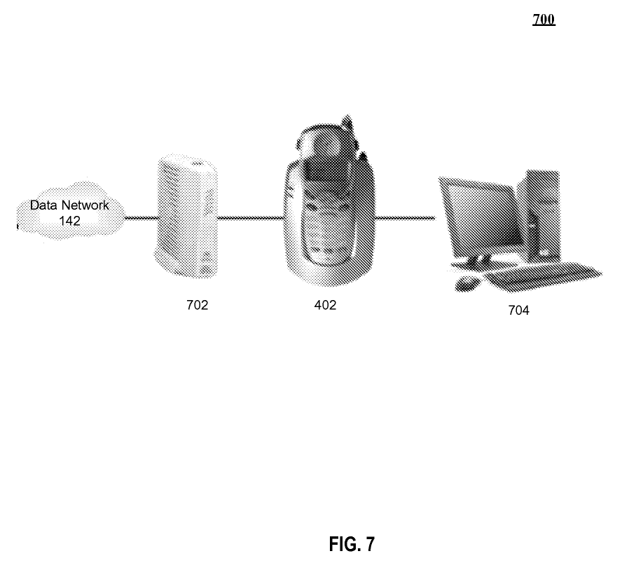

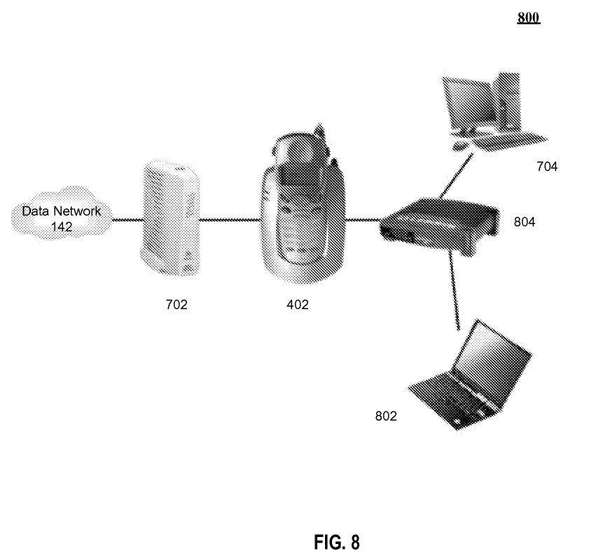

In one embodiment of FIG. 7 (network 700) master base station 402 serves the forgoing function with respect to packet voice communications transmitted and/or received between data network 142 (which may be the Internet) and master base station 402, which transmits and/or receives the same as cordless RF communications with handset 500. The foregoing applies to one embodiment of FIG. 8 (network 800).

In another exemplary embodiment, the above controllers(s) perform as a communications hub, wherein input data communications from a first data network are either (i) transmitted in the same manner as output data communications, or (ii) processed by the above controllers(s) for network-to-network connectivity, and output to a second network.

In one embodiment of FIG. 7 (network 700), master base station 402 serves as such a hub between a PC 704 and a modem 702 that modulates and demodulates data between the PC 704 and data network 142. Data network 142 may be the Internet. In this embodiment, master base station 402 includes an internal router (described below).

In one embodiment of FIG. 8 (network 800), master base station 402 serves as a hub between either a PC 704 or a notebook computer 802 and a modem 702 that modulates and demodulates data between the computers and data network 142. Data network 142 may be the Internet in this embodiment as well. In this embodiment, master base station 402 does not include an internal router (described below) or its router is not used.

In exemplary embodiments, data network communications is received or transmitted via LAN interface 626 and/or WAN interface 628. Although termed a “LAN” interface, interface 626 in actuality includes an interface to a single processor, such as a PC 704 (FIG. 7) or a notebook computer 802 (FIG. 8), a LAN 128a (FIG. 3), or an entire network of devices (not shown), which may include number other subnetworks (such as LANs) connected together. An exemplary interface for LAN interface 626 includes an Ethernet interface, although Token Ring, a fiber digital data interface (FDDI) and/or any other data networking interface may be used.

In an exemplary embodiment, WAN interface 628 provides a data networking connection to a single or multiple wide area networks. An exemplary wide area network is the Internet, a vast collection of inter-connected networks that are connected using the transmission control protocol/internet (TCP/IP) protocol, which evolved from the Advanced Research Projects Agency Network (ARPANET) of the late 1960's and early 1970's.

Data networking with either LAN interface 626 or WAN interface 628 may include any type of wireless communications. Exemplary types include, but not be limited to, code division multiple access (CDMA), spread spectrum wireless, orthogonal frequency division multiplexing (OFDM), 1G, 2G, 3G, nG, etc. wireless, Bluetooth, Infrared Data Association (IrDA), shared wireless access protocol (SWAP), “wireless fidelity” (Wi-Fi), WIMAX, IEEE standard 802.11 -compliant wireless local area network (LAN), 802.16 -compliant wide area network (WAN), and ultrawideband (UWB), to name a few.

The data networking component may also include router 624. Router 624 may be a special purpose computing device operable to route data, and/or a general purpose computing device executing routing software. Router 624 may be a data networking device that buffers and forwards data packets across an internetwork, such as the Internet, toward their ultimate destinations. The routing function of router 624 may occur in layer 3 of the Open Systems Interconnection (OSI) protocol stack. (IP is a layer 3 protocol.) A router must be used for an Internet connection. If an Internet connection is desired, and the master base station 402 does not include router 624 or if its function may be turned off by the user, the WAN interface 628 may be connected to an external router, either directly or indirectly, before being connected to the Internet.

As skilled persons will recognize, due to significant processing performed by the foregoing data networking components, master base station 402 may often generate substantial amounts of heat and/or varying forms of electromagnetic radiation. Conventional cordless phones which couple directly to circuit-switched telephone networks do not need to maintain a connection to the network.

An exemplary VOIP device (including, without limitation base stations 402-408 and/or wireless handset 500 ) may need to maintain a heartbeat or a substantially continuous communication session with a network 142, such that the VOIP devices may need to send and/or to receive packets to keep an open channel through a firewall, for example. Thus, the processor of the VolP device may be continually active. Processor 622 (or other processors such as communications processors), when executing, particularly when executing substantially continuously, can heat up and may cause heat to build up in the VolP device. As the processor in a base station unit continues to run, the base station unit may heat up as a result, and a handset in close proximity to the processor may in turn, heat up. If a handset becomes heated, this can be dangerous to a user, or may be perceived by a user as dangerous or inconvenient. The wireless handset 500, according to an exemplary embodiment, may be placed in the cradle of master base station 500 for recharging by power components 604 and/or batter charger 602, wireless handset 500 may absorb and transmit the heat and/or electromagnetic radiation, to the discomfort and potential danger of a caller. Handset units of a base station are often corded and placed a distance from the processor. According to an exemplary embodiment of the invention, a cordless handset may be used with a master base unit for the VolP device by providing a shield, or insulation to prevent, or minimize heat transfer to the handset. According to an exemplary embodiment of the present invention, a master base unit may accommodate cradling a cordless handset in the master base unit. According to an exemplary embodiment, the handset and/or the master base station unit may include, but may not be limited to, insulation, a heat shield, a vent, and/or may move the processor sufficiently far away from the handset to allow for the handset when cradled to maintain a commercially viable temperature level.

Element 630 (FIG. 6), according to an exemplary embodiment, may represent an isolation designed to prevent, minimize and/or reduce the transmission of heat and/or electromagnetic radiation from master base station 402 to the handset 500. In the embodiment shown, isolation 630 may be provided between one or more of the data networking and non-data networking components of master base station 402. The isolation 630 may isolate heat generating components of the device from radiating heat to the handset 500. In another exemplary embodiment (not shown) the isolation 630 encompasses all of the illustrated components of FIG. 6, thereby encapsulating the entire components of master base station 402. Skilled persons will recognize that any other combination yielding in the encapsulation of the data networking elements (or subcomponents thereof, which tend to transmit heat and/or electromagnetic radiation) may be provided.

As used herein, the isolation provided by isolation 630 may include any form of heat and/or electromagnetic radiation isolation. As one example, a relatively large distance may be used to effect such isolation. As another example, a heat and/or electromagnetic shielding or insulating material may be used to effect such isolation. It must be noted that the isolation 630 must be chosen such that it does not interfere with the cordless RF and/or VOIP communications of devices 402-408 and 500.

If a material is be used for shielding, it may be prefabricated to reduce or prevent heat and/or electromagnetic radiation, or the material may be subsequently treated, by being, for example, sprayed on, powdered on, or the like.

In differing embodiments, a number of protocols may be used by master base station 402 to effect the above VOIP functions. In one or more embodiments, a transport layer connection associated with the IP connection includes any (or combination) of: (i) a transmission control protocol (TCP) connection; (ii) a user datagram protocol (UDP) connection; (iii) a datagram congestion control protocol (DCCP) connection; and/or (iv) a stream control transmission protocol (SCTP) connection.

In one or more embodiments, the application layer connection associated with the IP connection includes any one (or combination) of: (i) a session initiation protocol (SIP) connection of the Internet Engineering Task Force (IETF); and (ii) an H.323 connection of the International Telecommunication Union (ITU).

### An Exemplary Computer System

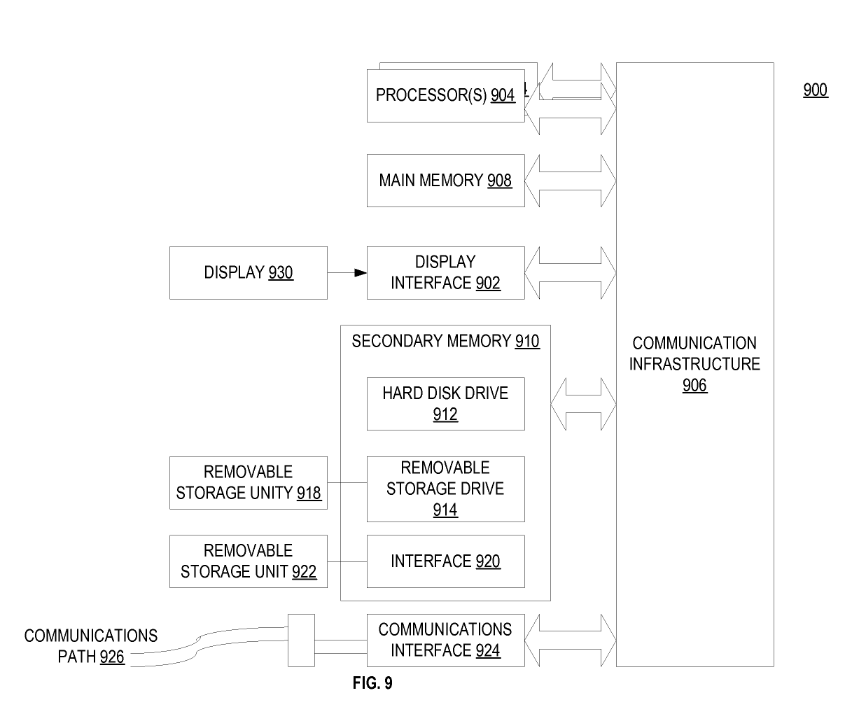

FIG. 9 depicts an exemplary embodiment of a computer system that may be used in computing devices such as, for example, but not limited to, client or server devices according to an exemplary embodiment of the present invention. FIG. 9 depicts an exemplary embodiment of a computer system that may be used as device 102, 104, base stations 402-408, devices 500, etc. The present invention (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 900 is shown in FIG. 9, depicting an exemplary embodiment of a block diagram of an exemplary computer system useful for implementing the present invention. Specifically, FIG. 9 illustrates an example computer 900, which in an exemplary embodiment may be, for example (but not limited to) a personal computer (PC) system running an operating system such as, for example (but not limited to) WINDOWS MOBILETM for POCKET PC, or MICROSOFT® WINDOWS® NT/98/2000/XP/CE/,etc. available from MICROSOFT® Corporation of Redmond, Wash., U.S.A., SOLARIS® from SUN® Microsystems of Santa Clara, Calif., U.S.A., OS/2 from IBM® Corporation of Armonk, N.Y., U.S.A., Mac/OS from APPLE® Corporation of Cupertino, Calif., U.S.A., etc., or any of various versions of UNIX® (a trademark of the Open Group of San Francisco, Calif., U.S.A.) including, for example, LINUX®, HPUX®, IBM AIX®, and SCO/UNIX®, or the like. However, the invention may not be limited to these platforms. Instead, the invention may be implemented on any appropriate computer system running any appropriate operating system. In one exemplary embodiment, the present invention may be implemented on a computer system operating as discussed herein. An exemplary computer system, computer 900 is shown in FIG. 9. Other components of the invention, such as, for example (but not limited to) a computing device, a communications device, a telephone, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 9.

The computer system 900 may include one or more processors, such as, for example (but not limited to) processor(s) 904. The processor(s) 904 may be connected to a communication infrastructure 906 (for example, but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 900 may include a display interface 902 that may forward, for example, but not be limited to, graphics, text, and other data, etc., from the communication infrastructure 906 (or from a frame buffer, etc., not shown) for display on the display unit 930.

The computer system 900 may also include, for example, but may not be limited to, a main memory 908, random access memory (RAM), and a secondary memory 910, etc. The secondary memory 910 may include, for example, (but not limited to) a hard disk drive 912 and/or a removable storage drive 914, representing a floppy diskette drive, a magnetic tape drive, an optical disk drive, a compact disk drive CD-ROM, etc. The removable storage drive 914 may, for example, but not be limited to, read from and/or write to a removable storage unit 918 in a well known manner. Removable storage unit 918, also called a program storage device or a computer program product, may represent, for example, but not be limited to, a floppy disk, magnetic tape, optical disk, compact disk, etc. which may be read from and written to by removable storage drive 914. As will be appreciated, the removable storage unit 918 may include a computer usable storage medium having stored therein computer software and/or data.

In alternative exemplary embodiments, secondary memory 910 may include other similar devices for allowing computer programs or other instructions to be loaded into computer system 900. Such devices may include, for example, a removable storage unit 922 and an interface 920. Examples of such may include a program cartridge and cartridge interface (such as, for example, but not limited to, those found in video game devices), a removable memory chip (such as, for example, but not limited to, an erasable programmable read only memory (EPROM), or programmable read only memory (PROM) and associated socket, and other removable storage units 922 and interfaces 920, which may allow software and data to be transferred from the removable storage unit 922 to computer system 900.

Computer 900 may also include an input device such as, for example, but not limited to, a mouse or other pointing device such as a digitizer, and a keyboard or other data entry device (none of which are labeled).

Computer 900 may also include output devices, such as, for example, but not limited to, display 930, and display interface 902. Computer 900 may include input/output (I/O) devices such as, for example, but not limited to communications interface 924, cable 928 and communications path 926, or the like. These devices may include, for example, but not limited be to, a network interface card, and modems (neither are labeled). Communications interface 924 may allow software and data to be transferred between computer system 900 and external devices.

In this document, the terms “computer program medium” and “computer readable medium” may be used to generally refer to media such as, for example, but not limited to, removable storage drive 914, a hard disk installed in hard disk drive 912, and the like. These computer program products may provide software to computer system 900. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. It has proven convenient at times, principally for reasons of common usage, to refer to the foregoing as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (for example, but not limited to a computer). For example, a machine-readable medium may include read only memory (ROM); random access memory (RAM); magnetic disk storage media; optical storage media; and/or flash memory devices, etc.

Computer programs (also called computer control logic), may include object oriented computer programs, and may be stored in main memory 908 and/or the secondary memory 910 and/or removable storage units 914, also called computer program products. Such computer programs, when executed, may enable the computer system 900 to perform the features of the present invention as discussed herein. In particular, the computer programs, when executed, may enable the processor 904 to provide a method to resolve conflicts during data synchronization according to an exemplary embodiment of the present invention. Accordingly, such computer programs may represent controllers of the computer system 900.

In another exemplary embodiment, the invention may be directed to a computer program product comprising a computer readable medium having control logic (computer software) stored therein. The control logic, when executed by the processor 904, may cause the processor 904 to perform the functions of the invention as described herein. In another exemplary embodiment where the invention may be implemented using software, the software may be stored in a computer program product and loaded into computer system 900 using, for example, but not limited to, removable storage drive 914, hard drive 912 or communications interface 924, etc. The control logic (software), when executed by the processor 904, may cause the processor 904 to perform the functions of the invention as described herein. The computer software may run as a standalone software application program running atop an operating system, and/or may be integrated into the operating system, etc.

In yet another embodiment, the invention may be implemented primarily in hardware using, for example, but not limited to, hardware components such as application specific integrated circuits (ASICs), or one or more state machines, etc. Implementation of the hardware state machine so as to perform the functions described herein will be apparent to persons skilled in the relevant art(s).

In another exemplary embodiment, the invention may be implemented primarily in firmware.

In yet another exemplary embodiment, the invention may be implemented using a combination of any of, for example, but not be limited to, hardware, firmware, and software, or the like.

Exemplary embodiments of the invention may also be implemented as instructions stored on a machine-readable medium, which may be read and executed by a computing platform to perform the operations described herein. A machine-readable medium may include any mechanism for storing or transmitting information in a form readable by a machine (for example, but not limited to, a computer). For example, a machine-readable medium may include read only memory (ROM); random access memory (RAM); magnetic disk storage media; optical storage media; and/or flash memory devices, etc.

The exemplary embodiment of the present invention makes reference to wired or wireless networks. Wired networks include any of a wide variety of well known means for coupling voice and data communications devices together. A brief discussion of various exemplary wireless network technologies that may be used to implement the embodiments of the present invention are presented as follows. The examples are non-limited. Exemplary wireless network types may include, for example, but not be limited to, code division multiple access (CDMA), spread spectrum wireless, orthogonal frequency division multiplexing (OFDM), 1G, 2G, 3G, nG, wireless, Bluetooth, Infrared Data Association (IrDA), shared wireless access protocol (SWAP), “wireless fidelity” (Wi-Fi), WIMAX, and other IEEE standard 802.11 -compliant wireless local area network (LAN), 802.16 -compliant wide area network (WAN), and ultrawideband (UWB), etc.

Bluetooth is a wireless technology specifying specifies how mobile phones, computers and PDAs interconnect with computers, each other, or office or home phones. The Bluetooth technology currently enables data connections between electronic devices in the 2.4 GHz range.

IrDA is a standard method for devices to communicate using infrared light pulses, as promulgated by the Infrared Data Association from which the standard gets its name. Since IrDA devices use infrared light, they may depend on being in line of sight with each other.

The exemplary embodiments of the present invention may make reference to WLANs. Examples of a WLAN may include a shared wireless access protocol (SWAP) developed by Home radio frequency (HomeRF), and wireless fidelity (Wi-Fi), a derivative of IEEE 802.11, advocated by the wireless Ethernet compatibility alliance (WECA). The IEEE 802.11 wireless LAN standard refers to various technologies that adhere to one or more of various wireless LAN standards. An IEEE 802.11 compliant wireless LAN may comply with any of one or more of the various IEEE 802.11 wireless LAN standards including, for example, but not be limited to, wireless LANs compliant with IEEE std. 802.11 a, b, d or g, such as, e.g., but not limited to, IEEE std. 802.11 a, b, d and g (including, for example, but not limited to IEEE 802.11 g-2003, etc.), or the like.

Conclusion

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A apparatus comprising:
a cordless component operable to communicate with one or more wireless handsets over a cordless radio frequency (RF) connection; and
a voice over Internet protocol (VOIP) component operable to communicate voice data over an Internet protocol (IP) coupled to an IP network via packet data communications.

2. The apparatus according to claim 1, wherein the apparatus comprises a master base station operable to communicate with a said wireless handset and/or one or more extension base stations remote from said master base station over a cordless RF connection, each said cordless extension operable to communicate with a said wireless handset over a cordless RF connection.

3. The apparatus according to claim 1, wherein said cordless component and said VOIP component are separated by a shield operable to reduce dispersal of any of: heat; and/or electromagnetic radiation, between said components.

4. The apparatus according to claim 3, wherein said shield further comprises features adapted to minimize interfere with any of: cordless RF communications; and/or VOIP packet data communications, of the apparatus.

5. The apparatus according to claim 1, wherein the apparatus comprises a master base station, and wherein the cordless component comprises at least one of:
a radio component operable to perform any of: transmitting a cordless RF signal from the master base station to a cordless device; and/or receive a cordless RF signal at the master base station from a cordless device;
a power component operable to recharge the power source of the master base station;
an input and/or output component operable to perform any of: receiving an input into the master base station, and/or transmitting an output from the master base station;
an interface with non-cordless devices; and/or
a controller operable to control said radio component, said power component, said input and/or output component and/or said interface of the master base station.

6. The apparatus according to claim 5, wherein said interface comprises any of: an interface to the public switched telephone network; and/or a data network interface.

7. The apparatus according to claim 5, wherein the master base station uses any of: a Digital Enhanced Cordless Telecommunications (DECT) standard; and/or a Personal Handy-phone System (PHS) standard.

8. The apparatus according to claim 5, wherein the VOIP component comprises:
a VOIP interface operable to communicate with said controller;
a central processing unit (CPU) operable to communicate with said VOIP interface and control any of: converting a voice information bearing data packet to a digital cordless RF signal; and/or converting a digital cordless RF signal to a voice information bearing data packet;
a local area network (LAN) interface for communicating with any of: a single digital device; and/or a plurality of data devices connected over a LAN; and
a wide area network (WAN) interface for communicating with any of: the Internet; and/or another wide area data network.

9. The apparatus according to claim 8, further comprising a router coupled to said WAN interface.

10. The apparatus according to claim 1, wherein a transport layer connection associated with said IP connection comprises any of:
a transmission control protocol (TCP) connection;
a user datagram protocol (UDP) connection;
a datagram congestion control protocol (DCCP) connection; and/or
a stream control transmission protocol (SCTP) connection.

11. The apparatus according to claim 1, wherein an application layer connection associated with said IP connection comprises any of:
a session initiation protocol (SIP) connection of the Internet Engineering Task Force (IETF); and/or
an H.323 connection of the International Telecommunication Union (ITU).

12. A system comprising:
a network supporting the Internet protocol (IP);
said network operable to communicate with a master base station, said master base station comprising:
a cordless component operable to communicate with one or more wireless handsets over a cordless radio frequency (RF) connection; and
a voice over Internet protocol (VOIP) component operable to communicate voice data over an IP coupling to the network via packet data communications.

13. The system according to claim 12, further comprising:
one or more extension base stations remote from said master base station and operable to communicate with said master base station over a cordless RF connection, each said extension base station operable to communicate with a said wireless handset over a cordless RF connection.

14. The system according to claim 12, further comprising a shield between said cordless component and said VOIP component, the shield operable to reduce dispersal of any one of: heat; and electromagnetic radiation, between said components.

15. The system according to claim 14, wherein said shield further comprises a feature operable to minimize interference with any of: cordless RF communications; and/or VOIP packet data communications, of the apparatus, and wherein said shield comprises at least one of: an insulator; a thermal shield; and/or a radiation shield.

16. The system according to claim 12, wherein the cordless component comprises at least one of:
a radio component operable to perform any of: transmitting a cordless RF signal from the master base station to a said wireless handset; and/or receiving a cordless RF signal at the master base station from a said wireless handset;
a power component operable to recharge the power source of the master base station;
an input and/or output component operable to perform any of: receiving an input into the master base station, and/or transmitting an output from the master base station;
an interface with non-cordless devices; and/or
a controller operable to control said radio component, said power component, said input and/or output component and/or said interface of the master base station.

17. The system according to claim 16, wherein the VOIP component comprises:
a VOIP interface operable to communicate with said controller;
a central processing unit (CPU) operable to communicate with said VOIP interface and control any of: converting a voice information bearing data packet to a digital cordless RF signal; and/or converting a digital cordless RF signal to a voice information bearing data packet;
a local area network (LAN) interface for communicating with any of: a single digital device; and/or a plurality of data devices connected over a LAN; and
a wide area network (WAN) interface for communicating with any of: the Internet; and/or another wide area data network.

18. A method comprising:
a first communicating with one or more wireless handsets over a cordless radio frequency (RF) connection; and
a second communicating voice data over an Internet protocol (IP) coupled to an IP network via packet data communications.

19. The method according to claim 18, wherein said first and said second communicating are performed by a master base station, and wherein a component operable to perform the first and a component operable to perform the second communicating are separated by a shield operable to reduce dispersal of any of: heat; and/or electromagnetic radiation, between said components.

20. A machine readable medium that provides instructions, which when executed by a computing platform, cause said computing platform to perform operations comprising a method, the method comprising:
communicating with one or more wireless handsets over a cordless radio frequency (RF) coupling; and
communicating voice data over an Internet protocol (IP) coupling to an IP network via packet data communications.
